(19) United States
(12) Patent Application Publication
(10) Pub. No.: US 2007/0234609 A1
(43) Pub. Date: Oct. 11, 2007

(54) Lighted sign

(76) Inventor: Albert Silvio Benoit, Redford, MI (US)

Correspondence Address: HARSHAW RESEARCH, INC., 210 W. TECUMSEH STREET, OTTAWA, KS, 66067, US

(21) Appl. No.: 11/374,754

(22) Filed: Mar. 14, 2006

(51) Int. Cl. G09F 13/28

(52) U.S. Cl. 40/550

(57) ABSTRACT

A lighted sign for displaying address information includes a display for visually presenting address information, a power source for energizing the display, and an input device for obtaining address information to be displayed. The display includes a plurality of LED's. The sign includes a processor for actuating a first set of LED's to present the address information in a horizontal direction when the display is at a horizontal mode and for actuating a second set of LED's to present the address information in a vertical direction when the display is at a vertical mode. The sign further includes an orientation sensor in communication with the processor for selecting between horizontal and vertical modes. A light sensor is in communication the processor such that the LED's are actuated only under predetermined light conditions. The sign includes a mount for enabling the display to be moved between horizontal and vertical conditions.

### BACKGROUND OF THE INVENTION

The present invention relates generally to address signage and, more particularly to a lighted address that includes a display having a field of LED's that may be actuated to present address information in either a horizontal or vertical direction depending on the physical orientation of the display.

Most people have experienced the difficulty of finding an unfamiliar residence in the dark. Reading the number of an address is difficult due to the location of the address sign or because of inadequate lighting. Address signs may also be partially obscured by bushes, parked cars, or just because porch lights are burned out or not turned on. At the very least, these difficulties can add several minutes to a person's arrival at a desired location and, unfortunately, may have tragic consequences in an emergency situation.

Various proposals have been made in the prior art for illuminating address signs. Although assumably effective for their intended purposes, existing lighted signs still do not provide an illuminated display that is user-programmable, highly visible, and mountable in multiple configurations.

Therefore, it would be desirable to have a lighted address sign which a user may program to display address information. Further, it is desirable to have a lighted sign that may be mounted to display address information in a horizontal or vertical direction. In addition, it would be desirable to have a lighted address sign that may include a solar power collector, rechargeable battery, orientation sensor, and light sensor.

### SUMMARY OF THE INVENTION

Accordingly, a lighted address sign according to the present invention includes a display having a plurality of LED's and that may be mounted in either a horizontal or vertical configuration. The sign includes an input device for receiving address information and a processor for actuating the LED's to display the address information in either a horizontal or vertical direction depending on the orientation of the display. The lighted sign may include an orientation sensor in communication with the processor for determining the orientation thereof such that the processor can actuate a first or second set of the LED's to present the address information in a corresponding direction. The lighted sign also includes a light sensor for allowing the LED's to be activated only under predetermined lighting conditions, e.g. at night.

Therefore, a general object of this invention is to provide a lighted address sign having a field of LED's for displaying address information to be viewed clearly from a distance.

Another object of this information is to provide a lighted address sign, as aforesaid, having a user input for receiving address information and a processor for actuating appropriate LED's to display the inputted address information.

Still another object of this information is to provide a lighted address sign, as aforesaid, that may be mounted in a horizontal or vertical orientation.

Yet another object of this information is to provide a lighted address sign, as aforesaid, having an orientation sensor in communication with the processor such that the processor actuates appropriate LED's to display the address information in either a horizontal or vertical direction.

A further object of this information is to provide a lighted address sign, as aforesaid, that actuates respective LED's to display address information only in predetermined light conditions.

A still further object of this information is to provide a lighted address sign, as aforesaid, that is durable, able to withstand severe weather conditions, and inexpensive to manufacture.

A particular object of this information is to provide a lighted address sign, as aforesaid, that includes a solar collection mechanism for charging a rechargeable battery.

Other objects and advantages of the present invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a lighted address sign in a vertical mounted configuration according to a preferred embodiment of the present invention;

FIG. 2a is a perspective view of the lighted address sign as in FIG. 1 in a horizontal mounted configuration;

FIG. 2b is another perspective view of the lighted address sign as in FIG. 2a mounted to a ground stake;

FIG. 3 is an exploded view of the lighted address sign as in FIG. 2a;

FIG. 4 is a front view of the display as in FIG. 3;

FIG. 5a is a perspective view of the solar collector as in FIG. 3;

FIG. 5b is a front view of the solar collector as in FIG. 3;

FIG. 5c is another perspective view of the solar collector as in FIG. 5a;

FIG. 6 is another perspective view of the lighted address sign with the solar collector in another configuration;

FIG. 7a is an isolated perspective view of the attachment device as in FIG. 3;

FIG. 7b is an isolated perspective view of the ground stake as in FIG. 2b; and

FIG. 8 is a block diagram of the electronic components of the present invention.

### DESCRIPTION OF THE PREFERRED EMBODIMENT

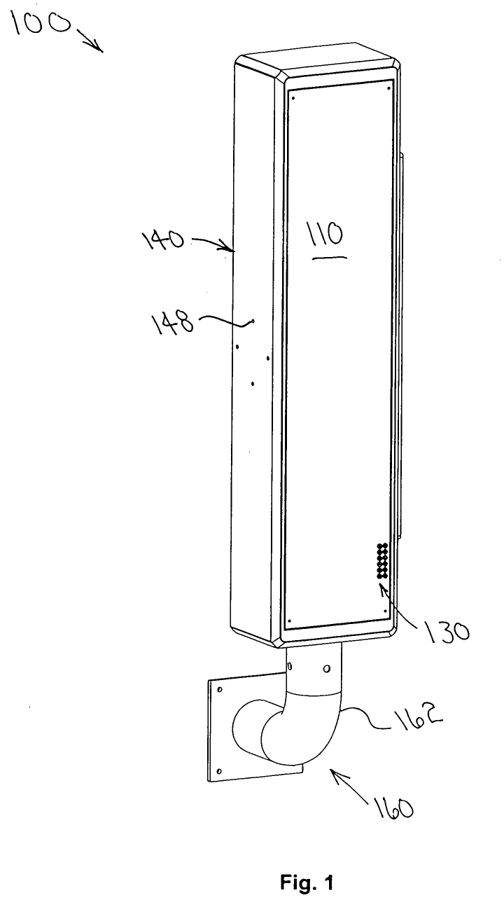

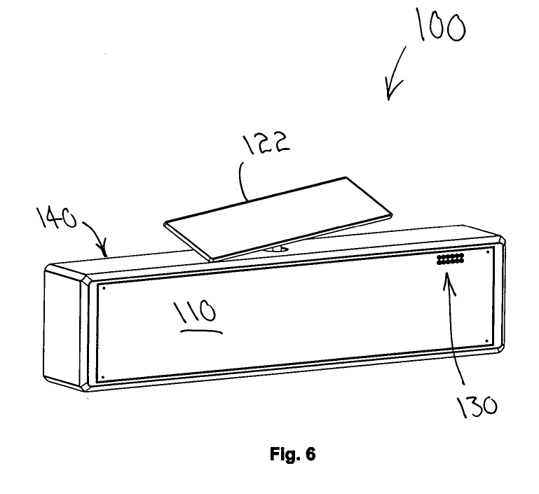

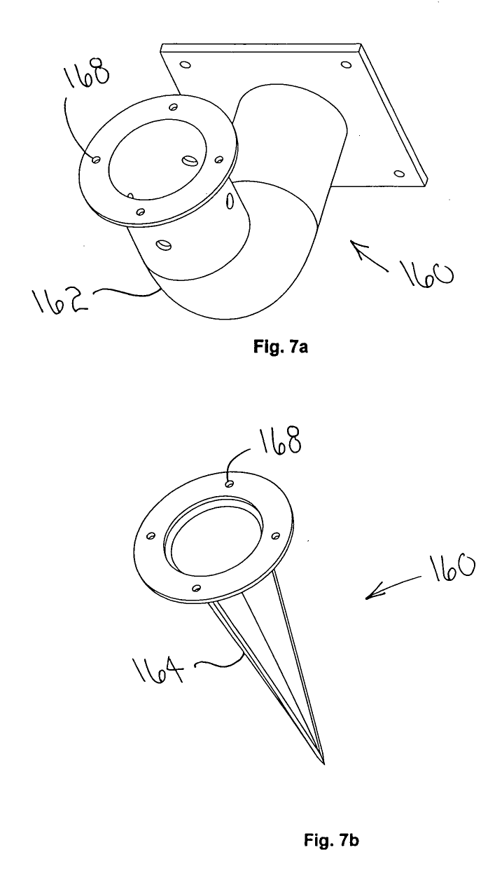

A lighted sign 100 according to the present invention will now be described in detail with reference to FIGS. 1 through 8 of the accompanying drawings. More particularly, a lighted sign 100 according to the current invention includes a display 110 for visually presenting information (e.g., address information), a power source 120 for energizing the display 110, and an input device 130 for obtaining the information to be presented by the display 110.

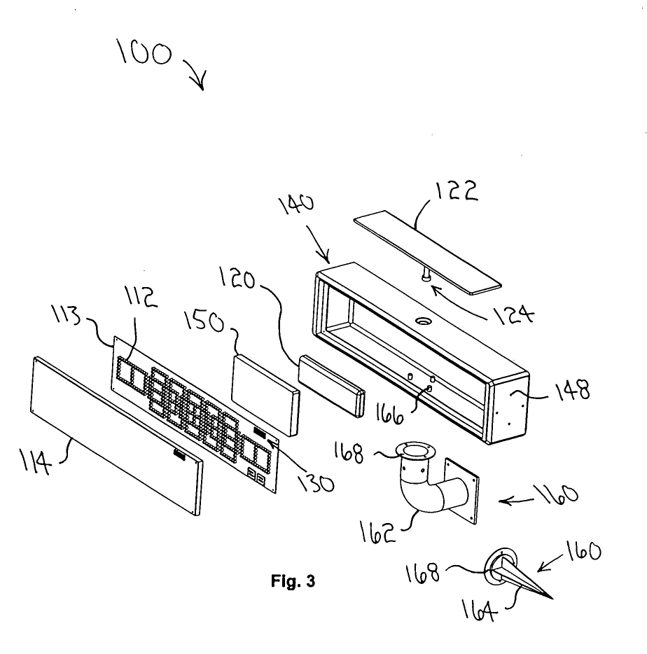

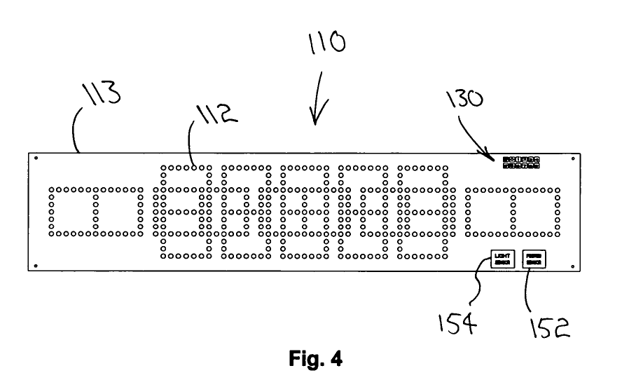

The display 110 may include a field of LED's 112 (FIG. 4), which may be attached to a printed circuit board 113 and protected by a cover 114 (FIG. 3), for example; an array of light bulbs; or other technology used in visually presenting information. As shown throughout the drawings, the display 110 may be attached to a housing 140. Preferably, the field of LED's provides for a five digit display to accommodate most addresses although it is understood that other configurations are possible, including alphanumeric displays. The display may also be a digital display for representing graphic or other characters.

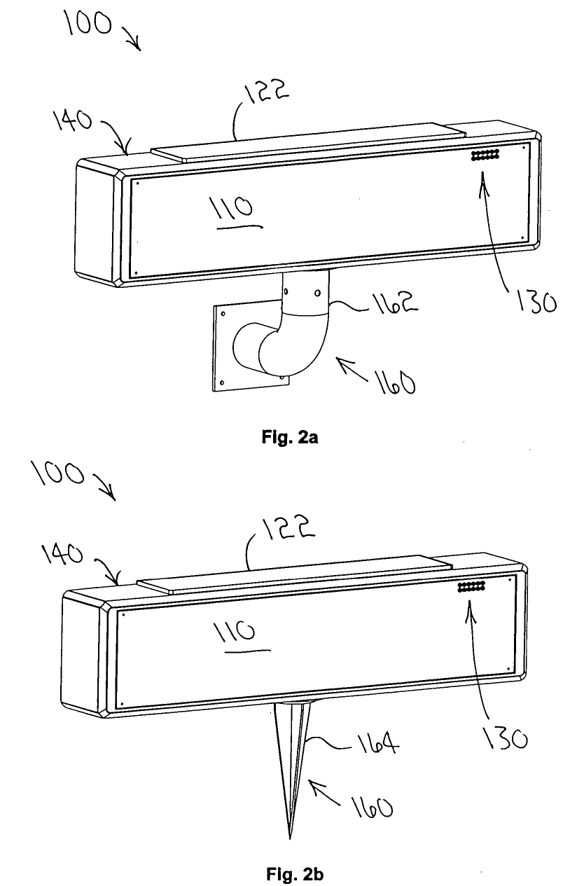

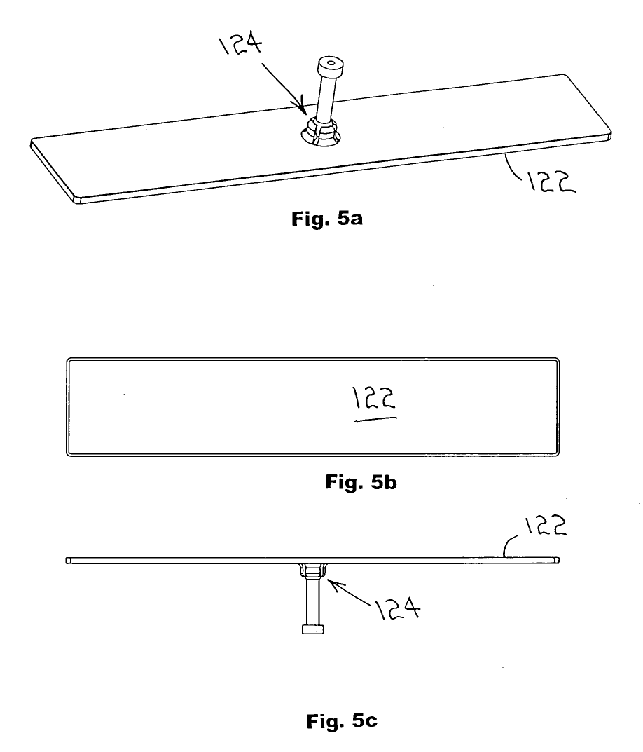

The power source 120 (FIG. 3) may be a rechargeable battery, and a solar energy collector 122 may be included for charging the battery 120. The battery 120 may be contained in the housing 140 as shown in FIG. 3. The solar energy collector 122 may be fixedly attached to the housing 140 (FIGS. 1 through 2b), or the solar energy collector 122 may be movably coupled to the housing 140 (FIGS. 3 and 5a through 6). While the solar energy collector 122 is shown coupled to the housing 140 by a ball and socket joint 124 (FIGS. 3, 5a, and 5c) to allow both angular and rotational movement, other configurations could also be used.

The input device 130 may be a keypad (FIGS. 1 through 3) or a remote controlled input device, for example. As shown in FIG. 3, the keypad input device 130 may be in data communication with the printed circuit board 113.

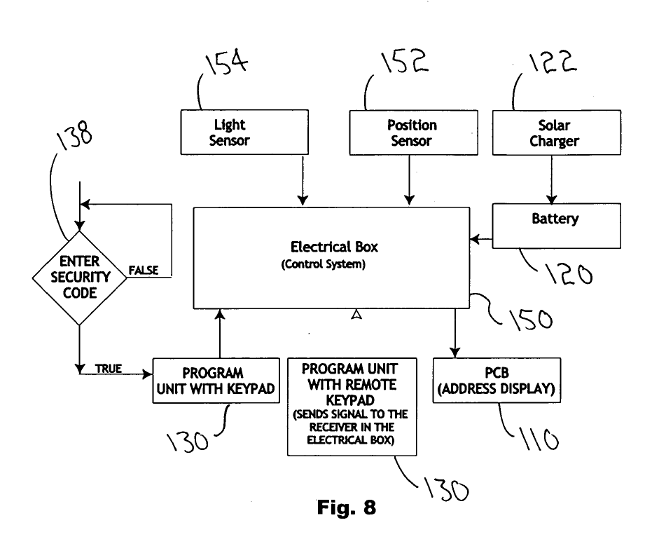

A processor 150 may be contained in the housing 140 (FIG. 3). The processor 150 preferably includes programming for receiving information from the input device 130 and actuating the display 110 to visually present the information (e.g., address information, greeting information, etc.). More particularly, the processor 150 preferably includes programming for actuating the display 110 in a first manner to visually present the information in a horizontal direction when the processor 150 is at a horizontal mode and for actuating the display 110 in a second manner to visually present the information in a vertical direction when the processor 150 is at a vertical mode. For example, a first set of predetermined LED's 112 may be actuated when the processor 150 is at the horizontal mode, and a second set of predetermined LED's 112 may be actuated when the processor 150 is at the vertical mode. Means may be included for selecting between the horizontal and vertical modes, such as a switch or an orientation sensor 152 in data communication with the processor 150 (FIGS. 4 and 8).

A light sensor 154 (FIGS. 4 and 8) may be in data communication with the processor 150 to provide light information, and the processor 150 may include programming for actuating the display 110 only under predetermined lighting conditions (i.e., when it is dark).

At least one attachment device 160 may be included for maintaining the housing 140 in either a horizontal (FIGS. 2a, 2b) or a vertical (FIG. 1) direction. The attachment device 160 may include a mount 162 (FIGS. 1, 2a, and 3) for affixing the housing 140 in either a horizontal or a vertical direction to an object (e.g., a house or a post) or a ground stake 164 (FIGS. 2b and 3) for securing the housing 140 in either a horizontal or a vertical direction to a ground surface. Fasteners 166 (e.g., bolts, screws, pins, etc.) may couple the attachment device 160 to the housing 140 by passing through corresponding holes 148, 168 defined by the housing 140 and the attachment device 160 (FIG. 3).

In use, the housing 140 may be coupled to an attachment device 160 as described above, and the attachment device 160 may be coupled to another object or the ground. Information (e.g., address information) may be input through input device 130, though the processor 150 may require a security code (shown at 138 of FIG. 8) to be correctly input before new information will be accepted. The battery 120 may energize the processor 150, the input device 130, and the display 110, and the solar energy collector 122 may recharge the battery 120. Once a predetermined lighting condition is detected from information provided by the light sensor 154, the processor 150 may actuate the display 110 to present the information as described above. The processor 150 may actuate the display 110 in either the first manner or the second manner depending on whether the horizontal or vertical mode has been selected by the orientation sensor 152.

It is understood that while certain forms of this invention have been illustrated and described, it is not limited thereto except insofar as such limitations are included in the following claims and allowable functional equivalents thereof.

What is claimed is as follows:

1. A lighted address sign, comprising:
a display for visually presenting address information;
a power source for energizing said display; and
an input device for obtaining said address information.

2. The sign as in claim 1, wherein:
said display includes an elongate field of LED's; and
said sign further comprising a processor for receiving said address information from said input device and actuating predetermined said LED's to visually present said address information.

3. The sign as in claim 2, wherein said processor includes programming for:
actuating a first set of predetermined said LED's to visually present said address information in a horizontal direction when at a horizontal mode; and
actuating a second set of predetermined said LED's to visually present said address information in a vertical direction when at a vertical mode.

4. The sign as in claim 3, further comprising an orientation sensor for selecting between the horizontal and vertical modes.

5. The sign as in claim 1, wherein:
said power source is a rechargeable battery; and
said sign further comprises a solar energy collector for charging said battery.

6. The sign as in claim 5, wherein:
said display is attached to a housing; and
said solar energy collector is movably coupled to said housing.

7. The sign as in claim 1, wherein:
said display is attached to a housing; and
said sign further comprises a mount for affixing said housing in either a horizontal or a vertical direction to an object.

8. The sign as in claim 1, wherein:
said display is attached to a housing; and
said sign further comprises a ground stake for securing said housing in either a horizontal or a vertical direction to a ground surface.

9. The sign as in claim 1, wherein said input device is a remote controlled input device.

10. The sign as in claim 1, wherein said input device is a keypad.

11. The sign as in claim 1, wherein:
said display includes a field of LED's;
a processor receives said address information from said input device and:
actuates a first set of predetermined said LED's to visually present said address information in a horizontal direction when at a horizontal mode; and
actuates a second set of predetermined LED's to visually present said address information in a vertical direction when at a vertical mode; and
said sign further comprises means for selecting between said horizontal and vertical modes.

12. The sign as in claim 11, wherein:
said power source is a rechargeable battery; and
said sign further comprises a solar energy collector for charging said battery.

13. The sign as in claim 12, wherein:
said display is attached to a housing;
said battery is contained in said housing; and
said solar energy collector is movably coupled to said housing.

14. The sign as in claim 11, further comprising an orientation sensor for selecting between the horizontal and vertical modes.

15. The sign as in claim 11, further comprising a light sensor in data communication with said processor, and wherein said processor includes programming for actuating the display only under predetermined lighting conditions.

16. The sign as in claim 11, further comprising at least one attachment device for maintaining said housing in either a horizontal or a vertical direction.

17. A lighted sign, comprising:
a display for visually presenting information;
a power source for energizing said display;
an input device; and
a processor for receiving said information from said input device and actuating said display to visually present said information, said processor including programming for:
actuating said display in a first manner to visually present said information in a horizontal direction when at a horizontal mode; and
actuating said display in a second manner to visually present said information in a vertical direction when at a vertical mode.

18. The sign as in claim 17, wherein:
said power source is a rechargeable battery;
said display is attached to a housing;
said battery is contained in said housing; and
said sign further comprises a solar energy collector for charging said battery, said solar energy collector being movably coupled to said housing.

19. The sign as in claim 18, wherein said solar energy collector is coupled to said housing by a ball and socket joint.

20. The sign as in claim 17, further comprising at least one attachment device for maintaining said housing in either a horizontal or a vertical direction.
